(19) United States
(12) Patent Application Publication
(10) Pub. No.: US 2014/0250290 A1
(43) Pub. Date: Sep. 4, 2014

(54) Method for Software Anti-Rollback Recovery

(71) Applicant: ST-ERICSSON SA, Plan-les-Ouates (CH)

(72) Inventors: Per Ståhl, Klagshamn (SE); Håkan Englund, Lund (SE); Hans Holmberg, Malmo (SE)

(73) Assignee: ST-ERICSSON SA, Plan-les-Ouates (CH)

(21) Appl. No.: 13/781,852

(22) Filed: Mar. 1, 2013

(51) Int. Cl. G06F 9/44

(52) U.S. Cl. CPC G06F 9/4401
USPC 713/2

(57) ABSTRACT

A temporary anti-rollback table—which is cryptographically signed, unique to a specific device, and includes a version number—is provided to an electronic device requiring a replacement anti-rollback table. The table is verified by the device, and loaded to memory following a reboot. The memory image of the table is used to perform anti-rollback verification of all trusted software components as they are loaded. After booting, the memory image of the table is written in a secure manner to non-volatile memory as a replacement anti-rollback table, and the temporary anti-rollback table is deleted. The minimum required table version number in OTP memory is incremented. The temporary anti-rollback table is created and signed using a private key at authorized service centers; a corresponding public key in the electronic device verifies its authenticity.

### FIELD OF INVENTION

The present invention relates generally to software security, and in particular to replacing an anti-rollback mechanism on an electronic device.

### BACKGROUND

Electronic devices (and in particular, portable electronic devices) are a ubiquitous part of modern life in many areas. Examples include wireless telecommunication terminals (e.g., cellular radiotelephones, “smartphones,” etc.), satellite navigation receivers, computing devices (e.g., laptop and netbook computers, personal digital assistants, etc.) medical and environmental monitoring devices, and many others. Critical to the functionality of many electronic devices is software, and the security of that software against hacking, spoofing, and the like is an ongoing concern.

This concern may be illustrated by a consideration of software security issues in mobile telecommunication terminals (note that this class of electronic devices is merely representative for the purposes of discussion, and embodiments of the present invention are not limited to telecommunication applications). As one example, the business model for mobile telecommunication terminal sales in many areas is that the costs of the electronic devices are subsidized by telecommunication service providers, as part of a service contract of a specified minimum duration (e.g., two years). This model provides an incentive for “hacking,” or alteration of software within the electronic device, allowing a subscriber to obtain service from a different service provider. As another example, an electronic device manufacturer may design and build a single device, which includes diverse functionality, and sell different models of the device, differentiated by enabling different levels of functionality via software. This creates an incentive for hacking the software in the device to enable functionality beyond that for which the consumer has paid. Many other incentives for hacking exist. Consequently, software security is an important aspect of the design and manufacture of electronic devices.

To enable software security, there is typically a Trusted Computing Base (TCB) that is responsible for verification of other trusted software components. This TCB typically includes cryptographic functionality, and data (e.g., random numbers, chip-specific keys, public or private cryptographic keys, or the like) stored in One Time Programmable (OTP) memory. OTP memory, also known as write-once memory, comprises an array of fusible links or other technology that, once written—that is, once the state of a bit is changed—it cannot be changed back. Data in OTP memory can only be altered by (permanently) flipping additional bits (i.e., it can be incremented).

Many electronic devices include “secure” or “trusted” execution capability. In this case the TCB typically incorporates parts of the Trusted Execution Environment (TEE). The trusted execution environment may be implemented on a separate processor—one (or more) general-purpose processors for the rich OS and one secure processor for the TEE, either physically separate or separate cores integrated on one chip—or the rich execution environment and the trusted execution environment may be separate modes of operation of a single processor. The TRUSTZONE® feature of the ARM® processor architecture is an example of the latter. Applications executing in the trusted execution environment are referred to as trusted applications. Additionally, the trusted execution environment core and trusted applications execute from a secure memory, which is inaccessible from the rich OS and its applications.

To ensure proper security of software on an electronic device, software security must be implemented from the beginning of the initial boot process; otherwise a hacked boot loader or operating system software could take over and execute hacked code. Secure boot is thus the basis for the implementation of other security features in an electronic device. Secure boot is typically based on a standard public key infrastructure (PKI) solution. Each protected software component is digitally signed using a private key, and is verified using a corresponding public key that is available in the device. The secure boot process starts from ROM code that contains a verification core. There is a root public key available to the ROM code verification. This key may reside in non-volatile memory, and is bound to the device by storing a hash of the public key in OTP memory. The root public key is typically used to verify the first boot loader (that is, the first software component loaded by the ROM code) and/or a set of public keys used for verification of other software components. The first boot loader then loads and verifies the next boot loader, which then loads and verifies the next software component, and so on. The secure boot process guarantees the loading and verification of trusted SW components. Depending on the device, this may include all of the device software or part of the device software. As an example, for modern mobile phones proper execution of the secure boot process typically guarantees the loading and verification of the all code up to and including a rich operating system kernel (e.g., Linux), modem software, system control processor firmware, trusted execution environment software, and trusted applications.

Software anti-rollback, also known as software downgrade prevention, is typically part of the verifications performed during secure boot. Anti-rollback is a mechanism to prevent an older version of a software component, which contains a security bug, from being reinstalled and executed on a device where a newer version of that software component, in which the bug was corrected, has been installed. For software anti-rollback purposes, it is common to use a security revision number that is increased only when a security-sensitive bug is corrected. This security revision is normally distinct from the version number of the software component.

For each software component, the highest security revision number that has been installed on the device must be stored on the device. This can be done in many ways. One technique known in the art is for the TCB to store the security revision numbers in OTP memory. Each time a security revision is increased, a fuse is burnt (i.e., an OTP bit flipped) to increase the stored security revision number. Software components are then checked against these stored security revision numbers prior to loading and execution. While this worked well for single-purpose devices having one or only a few software components, it does not scale to modern, multi-purpose devices that often run complex operating systems, such as Linux. Such systems execute a large number of individual software components, and storage of security revision numbers per software component in OTP memory is a very costly solution.

A more cost efficient solution that is known in the art is to keep a table containing the highest security revision for each protected software component that has been installed on the device. This “anti-rollback table” is stored in non-volatile storage, such as embedded MultiMediaCard (eMMC) memory. There are two ways to securely store the anti-rollback table.

First, the anti-rollback table may be stored in non-volatile memory that is accessible also by non-trusted software. In this case, to prevent manipulation of the table, the table is integrity protected, e.g., using a Hash-based Message Authentication Code, such as HMAC-SHA-256, with a unique key that is only available to the TCB (e.g., a key derived from a random value unique to a processor or to the device, and stored in secure OTP memory). The anti-rollback table itself has a version number associated, which is stored, e.g., in OTP memory. Whenever the anti-rollback table is updated to reflect a later security revision number for one or more software components, the table version number is incremented by the TCB, and the stored version is updated, e.g., by flipping an OTP bit.

Second, the anti-rollback table may be stored in a non-volatile memory where the integrity of the table can be guaranteed. For example, a Replay Protected Memory Block (RPMB) area of the eMMC may be utilized. Integrity-protected reads and writes to RPMB use a key shared between the eMMC and the TCB, guaranteeing that non-trusted software cannot tamper with the data.

In case the device has a trusted execution environment, the TEE is typically a part of the TCB. The TEE provides the means to protect keys and cryptographic functionality of the TCB from the non-trusted SW such as rich OS applications or even the rich OS itself. For other less advanced devices without a TEE, other HW mechanisms can be utilized to protect keys and cryptographic functionality. For example, it is possible to temporary read- and write-lock protect the OTP area critical for SW anti-rollback until the next boot to prevent access to the key used in protection of the SW anti-rollback table or the protected communication with RPMB. Another example is to have this key never readable from SW, but readable only by the HW block performing the cryptographic operation. In this case there could be a temporary lock-down mechanism of this HW block preventing the use of this key in cryptographic operations until the next boot. A third example is to make use of MPU/MMU functionality of the CPU subsystem to isolate the non-trusted software from the trusted software, and prevent access to OTP and cryptographic HW from non-trusted SW.

As software components are loaded and verified, the security revision number of each is checked by the TCB against the corresponding security revision number in the anti-rollback table; an attempt to load a software component with an old security version results in a failed boot. The anti-rollback table is initialized and activated during production of the device, when the device is in an authenticated state, such as by initial settings of the OTP memory. After all software and configuration data are loaded onto the device, an OTP fuse may be burned to exit the device from authenticated state, and into an operational state, in which the anti-rollback table (as well as other secure parameters) can only be updated by the TCB following loading of an updated SW component with a higher security revision.

During the device lifetime the non-volatile storage may be broken such that the anti-rollback table is either lost or is broken (meaning its integrity cannot be verified). This will prevent the device from booting, as trusted software components loaded early in the boot process will fail anti-rollback verification. In this case the table needs to be re-initialized. However, the software that handles authentication and re-initialization of the anti-rollback table (including writing to non-volatile storage) does not load until later during the boot process. That is, numerous software components (loaders, drivers, and the like) must be loaded without anti-rollback protection, in order to repair or replace the anti-rollback table. This creates a significant security risk, which known anti-rollback techniques cannot mitigate.

The Background section of this document is provided to place embodiments of the present invention in technological and operational context, to assist those of skill in the art in understanding their scope and utility. Unless explicitly identified as such, no statement herein is admitted to be prior art merely by its inclusion in the Background section.

### SUMMARY

The following presents a simplified summary of the disclosure in order to provide a basic understanding to those of skill in the art. This summary is not an extensive overview of the disclosure and is not intended to identify key/critical elements of embodiments of the invention or to delineate the scope of the invention. The sole purpose of this summary is to present some concepts disclosed herein in a simplified form as a prelude to the more detailed description that is presented later.

According to one or more embodiments described and claimed herein, a temporary anti-rollback table—which is cryptographically signed, unique to a specific device, and includes a table version number—is provided to an electronic device requiring a replacement anti-rollback table. Following a reboot, the table is loaded into memory and verified by the device, and used to perform anti-rollback verification of all trusted software components as they are loaded. The memory image of the temporary anti-rollback table is updated if any software component has a later security revision number, or if a software component is not listed in the table. When sufficient software components are anti-rollback verified and loaded, the (possibly modified) memory image of the temporary anti-rollback table is written to non-volatile memory (either RPMB or public memory together with integrity information) as a replacement anti-rollback table, and the temporary anti-rollback table is deleted. The minimum temporary table version number in OTP memory, is also incremented, e.g., by flipping an OTP bit. This prevents reuse of the temporary anti-rollback table, which may be recoverable even after deletion, e.g., as a result of the wear-leveling feature of flash memory. The temporary anti-rollback table is created and cryptographically signed using a private key at authorized service centers; a corresponding public key in the electronic device verifies the authenticity of the temporary anti-rollback table. The service center must read a unique device ID and the minimum anti-rollback table version number that is required to be accepted from the device to sign the temporary anti-rollback table.

One embodiment relates to a method of recovery by an electronic device having a processor and having non-volatile memory and One Time Programmable (OTP) memory, in which an anti-rollback table is lost or corrupted. The device is rebooted. Boot code or a first secure software component initially loaded by boot code loads into memory, from a predetermined address, a temporary anti-rollback table having a version number and that has been cryptographically signed. The temporary anti-rollback table includes a minimum allowable security revision number for each of a plurality of software components. The validity of the temporary anti-rollback table is verified. Using the memory image of the temporary anti-rollback table, a security revision number of each software component subsequently loaded during the boot process is verified. After an appropriate memory write driver is loaded, the memory image of the temporary anti-rollback table is securely saved as a replacement anti-rollback table.

Another embodiment relates to a method of creating a temporary anti-rollback table for an electronic device. A unique device ID and a minimum required version number of an anti-rollback table are obtained from the device. A temporary anti-rollback table including an identification of all secure software components to be anti-rollback verified and a security revision number for each such software component is generated. The temporary anti-rollback table is cryptographically signed using a private key, the device ID, and the minimum required table version number. The temporary anti-rollback table is then provided to the device.

Yet another embodiment relates to an electronic device including a processor, non-volatile memory, and One Time Programmable (OTP) memory. The processor is operative to reboot the device, and then to load into memory, from a predetermined address, by boot code or a first secure software component initially loaded by boot code, a temporary anti-rollback table having a version number and that has been cryptographically signed. The temporary anti-rollback table includes a minimum allowable security revision number for each of a plurality of software components. The processor is further operative to verify the validity of the temporary anti-rollback table, and to verify, using the memory image of the temporary anti-rollback table, a security revision number of each software component subsequently loaded during the boot process. After an appropriate memory write driver is loaded, the processor is operative to securely save the memory image of the temporary anti-rollback table as a replacement anti-rollback table.

### BRIEF DESCRIPTION OF THE DRAWINGS

The present invention will now be described more fully hereinafter with reference to the accompanying drawings, in which embodiments of the invention are shown. However, this invention should not be construed as limited to the embodiments set forth herein. Rather, these embodiments are provided so that this disclosure will be thorough and complete, and will fully convey the scope of the invention to those skilled in the art. Like numbers refer to like elements throughout.

FIG. 1 is a functional block diagram relevant portions of an electronic device.

FIG. 2 is a flow diagram of a method of creating a temporary anti-rollback table for an electronic device.

FIG. 3 is a flow diagram of a method of recovery by an electronic device in which an anti-rollback table is lost or corrupted.

### DETAILED DESCRIPTION

It should be understood at the outset that although illustrative implementations of one or more embodiments of the present disclosure are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

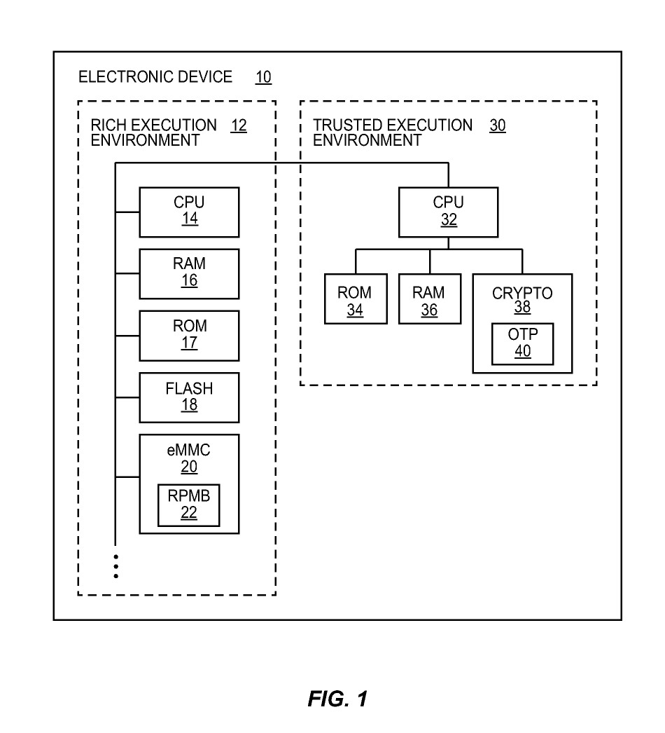

FIG. 1 depicts one operational view of computing resources in an electronic device 10, according to one or more embodiments of the present invention. During most normal operation, a rich execution environment 12 is operative. The rich execution environment 12 executes on a non-secure CPU 14, which may run a rich operating system, such as Linux, Windows CE, Android, or the like. The non-secure CPU 14 has access to RAM memory 16, ROM memory 17, and non-volatile memory such as flash memory 18. In one embodiment, in lieu of, or in addition to, the flash memory 18, the rich execution environment 12 includes flash memory 20 conforming to the embedded MultiMediaCard (eMMC) specification. The eMMC memory 20 includes a Replay Protected Memory Block (RPMB) 22, access to which requires authentication, such as using a secret key shared between the RPMB and a trusted execution environment 30.

During boot-up, and at other times when a secure processing environment is required (e.g., during cryptographic transactions such as authentication or encryption/decryption, during verification for Digital Rights Management (DRM) content, and the like), a trusted execution environment 30 is active. The trusted execution environment 30 executes on a secure CPU 32, which may comprise a separate processor from the non-secure CPU 14. Alternatively, a single processor may implement a non-secure CPU 14 in a default mode, and a secure CPU 32 in a trusted mode (e.g., the ARM® TRUSTZONE® architecture). In the trusted execution environment 30, the secure CPU 32 has exclusive access to secure ROM memory 34, RAM memory 36, and possibly cryptographic processing circuits 38. The cryptographic circuits 38 may have exclusive access to secure One Time Programmable (OTP) memory 40. The OTP memory 40 may be used for storing version numbers, unique random numbers, a device ID, secret or private cryptographic keys, and the like. In various embodiments, the trusted execution environment 30 may include additional functionality and/or hardware circuits. In general, memory and circuits within the trusted execution environment 30 may not be accessed by non-secure hardware or processes (e.g., non-secure CPU 14 or other circuits).

Of course, the electronic device may include many circuits and components not relevant here, and not depicted in FIG. 1, such as a radio-modem, GPS receiver, Input/Output features (touchscreen, keypad, etc.), compression/decompression engine, graphics processor, camera and image processing circuits, and the like.

For many modern electronic devices, the secure boot-up relies on a TCB, which incorporates parts of the trusted execution environment 30. As described above, an anti-rollback table may be loaded and verified, and security version numbers of trusted software components verified against the table prior to loading the software, to ensure that only the most recent versions—with fixes to all known bugs and security weaknesses—can be loaded. However, the anti-rollback table may be lost or corrupted, for example due to damage to non-volatile memory storing the table. According to embodiments of the present invention, secure methods are provided of restoring a valid, up-to-date anti-rollback table, while providing anti-rollback verification and protection from the first boot code through complete rich OS boot and the device 10 entering an operational state.

Most electronic devices 10 initially boot from ROM 34. The boot ROM code may not contain any support for software anti-rollback. In this case, software anti-rollback is handled by the first software component loaded by the boot ROM 34, referred to herein as the Initial Secure SoftWare (ISSW). ISSW is a part of the TCB and is loaded and executed in secure RAM 36 not accessible by the rich operating system or any other code executing in the rich execution environment 12. The software anti-rollback protection for ISSW is handled by the software component itself. As the very first task during its execution, the ISSW checks its security revision number as part of its signed image against a corresponding number in OTP memory 40. The OTP memory 40 stores the highest security revision number of any ISSW that has ever been loaded on the device 10. If the security revision of the signed image is greater than or equal to the value in OTP memory 40, then ISSW is accepted and continues to execute. Otherwise, the execution is immediately stopped. In case the security revision of the ISSW image is greater than the one in OTP 40, then OTP 40 bits are flipped such that the OTP 40 security revision number is equal to the one in the ISSW image.

The ISSW, which contains, or loads and verifies, the trusted execution environment 30 core and a static trusted application, contains the code for the anti-rollback verification. This code remains available in secure RAM 36 and can be called by other software components, when verifying the signature of a software component, to perform the software anti-rollback check. This code handles:
Loading of the anti-rollback table from non-volatile storage 18 or an RPMB partition 22 of eMMC 20 to a memory image thereof in secure RAM 36. If the anti-rollback table is loaded from non-volatile storage 18, the ISSW additionally reads integrity information and cryptographically verifies the table;
For each subsequent software component that attempts to load, checking a security revision number of the software component against the corresponding security revision number in the memory image of the table;
Updating the security revision number in the memory image of the table in case a software component is loaded that has a higher security revision than the one in the table; and
Updating the memory image of the table with a new entry (comprising at least a software component identifier and security revision number) in case a new protected software component not previously loaded has now been loaded and successfully verified.

If the memory image of the anti-rollback table is altered during the boot process—either by updating a software component's security revision number or by adding a new table entry—the memory image of the anti-rollback table must be saved to non-volatile memory 18, 22. However, while drivers operative to read flash memory may be available, the flash memory write drivers are typically not loaded until later in the boot process. Accordingly, the ISSW may set a flag in RAM 36, indicating that a write of the memory image of the anti-rollback table to non-volatile memory 18, 22 is to occur when the appropriate software components have been loaded. As described above, the memory image of the anti-rollback table may be written to non-secure, non-volatile memory 18, together with integrity information such as a HMAC-SHA-256 generated using a key stored in secure OTP memory 40. In this case, the version number of the anti-rollback table is also incremented in OTP 40, to preclude reuse of the (pre-modification) version of the anti-rollback table that was loaded into memory. Alternatively, the anti-rollback table may be written to a secure RPMB block 22 of eMMC 20, using a device-specific key shared between the RPMB 22 and the secure cryptographic circuit 38 (which key may also be generated using a key stored in secure OTP memory 40).

If the ISSW is unable to read the anti-rollback table, the boot process cannot proceed. In the case of a boot failure, a re-initialization of the device is performed in an authorized service center. This may comprise an interface boot over a USB or UART interface (not shown) to re-flash the device 10. If anti-rollback is enabled (e.g., an OTP bit was programmed during production of the device 10 to enable software anti-rollback), and the cause of the boot failure is a missing or corrupt anti-rollback table, a temporary, signed, anti-rollback table is issued for the particular device 10 to allow it to boot. A dedicated memory location 18 is defined for storing the temporary anti-rollback table. The temporary anti-rollback table is part of the software image downloaded via USB/UART when re-flashing the device, and may be also stored in flash memory 18 in case the boot is performed from flash 18. Note that the service center must obtain the value of the table version to be used in the temporary anti-rollback table from OTP memory 40, as well as a unique device ID, and include these parameter values in the cryptographic signature of the temporary anti-rollback table, as discussed in greater detail below. These parameters are obtained via boot ROM code or ISSW.

If anti-rollback is enabled and the original anti-rollback table failed to be loaded and verified, then ISSW requests the memory entry with the signed, temporary anti-rollback table (either over USB/UART or from flash 18). This table contains security revisions of the software components. The temporary anti-rollback table is signed using a private key available at the service center where the re-initialization is performed. The corresponding public key used to verify the table is part of the ISSW. The signed, temporary anti-rollback table is specific for a given device 10 and contains the public device ID of the device 10. During verification, it is checked that the signed, temporary anti-rollback table is valid for the particular device 10 by matching the public device ID of the device 10 to that of the signed table. The version number of the temporary anti-rollback table is also checked against the version stored in OTP memory 40.

If such a signed, temporary anti-rollback table is available and is successfully verified by the ISSW, then the table is loaded into RAM 36, and the memory image of the table is used as the operative anti-rollback table during boot. A state variable is set in secure RAM 36 indicating that this memory image of the anti-rollback table should be updated and written into non-volatile storage 18, 22 as a replacement anti-rollback table when the OS is booted and writing capability to non-volatile storage 18, 22 is available. Any updates during boot to the memory image of the anti-rollback table are made in the same manner described above. If the anti-rollback table is updated (either by incrementing a security revision number for a software component or by adding table entries for one or more software components), and the replacement anti-rollback table is stored to non-secure memory 18, then the anti-rollback table integrity (e.g., HMAC-SHA-256) is recalculated and stored with the table, and the version number of the table is incremented and a bit in OTP memory 40 is flipped to reflect the incremented anti-rollback table version number, additionally the minimum temporary table version number, in OTP 40, is incremented to revoke the temporary table. Alternatively, the replacement anti-rollback table may be stored to RPMB 22. In this case also, minimum temporary table version number, in OTP 40, is incremented, to revoke the temporary signed table.

Note that the boot via USB/UART makes it possible to load a flash loader and re-flash the device 10. The loader may have support to request the anti-rollback table from the trusted execution environment 30 and write it in public non-volatile memory 18 (in this case the table is integrity protected) if this is where the anti-rollback table is stored. In case of the table being stored in RPMB 22, the loader must be able to handle reading and writing the RPMB partition 22. The assumption when the anti-rollback table is not available in RPMB 22 is that the non-volatile storage device has been replaced, and that the RPMB 22 shared key needs to be shared to the new storage device. This requires authentication. If the loader supports authentication and reading and writing the RPMB partition 22, then the anti-rollback table can be restored.

If the loader lacks support for handling anti-rollback and authentication, then the temporary, signed, anti-rollback table must be stored also in non-volatile storage 18. It is used in the next platform boot from non-volatile storage 18. The same verifications using the signed table can be done as described above, but in this case the OS is booted and functionality is available for authentication, RPMB 22 key sharing, and writing of the replacement anti-rollback table to non-volatile storage 18, 22.

In the specific case that the device 10 is a radiotelephone having a modem in flashless bridge configuration—that is, where a modem circuit has no flash memory but is connected to a CPU 14 with access to flash memory 18, 20—an interface boot over UART/USB/HSI/HSIC/C2C or some other interface is performed. The complete modem software is stored in non-volatile memory 18, 20 including the temporary, signed, anti-rollback table that was put in memory 18, 20 when flashing the modem software image. The anti-rollback solution works the same as described above for the case of device 10 software boot. The modem boots up until the modem OS is running and then support is available to write the replacement anti-rollback table to non-volatile storage 18, via services available in the rich execution environment 12 (and utilizing keys from the trusted execution environment 30).

When the replacement anti-rollback table is successfully written, the temporary anti-rollback table is deleted. To prevent any re-installation of the temporary anti-rollback table by an attacker, the table contains a table version number. The minimum version of the signed anti-rollback table required to be accepted by the device 10 is stored in OTP memory 40. When the temporary anti-rollback table is deleted, the required minimum version is increased by at least one by flipping at least one bit in OTP 40. When verifying the signed anti-rollback table, it is also checked that the table version number is greater than or equal to the minimum anti-rollback table version number stored in OTP memory 40. This applies in the same manner in all of the above configurations. As already mentioned above, the deletion of the temporary anti-rollback table and the bit flipping in OTP 40 does not occur until the replacement anti-rollback table is successfully written back to non-volatile storage 18, 22. Hence, in case the boot is interrupted prior to the replacement anti-rollback table being successfully written back to non-volatile storage 18, 22, the temporary anti-rollback table may be used in more than one boot-up procedure until the replacement anti-rollback table is stored.

Note that, as mentioned above, it must be possible to extract the minimum version number of the anti-rollback table stored in OTP memory 40, as well as a unique device ID, from the device 10. This is needed when creating a temporary anti-rollback table in the service center.

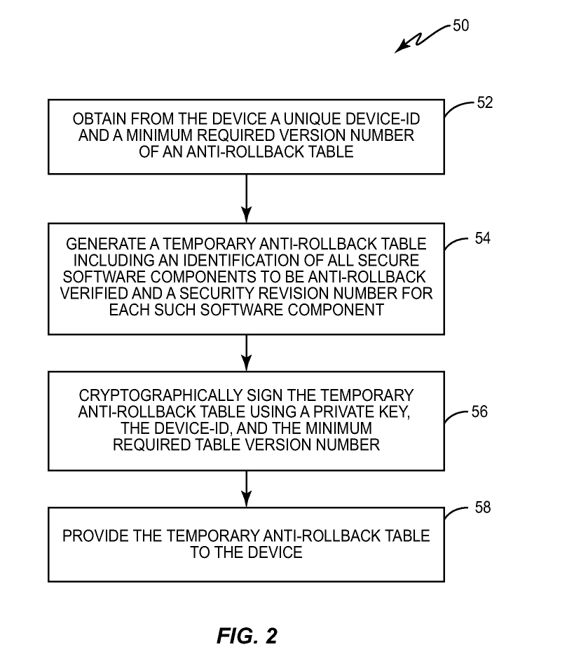

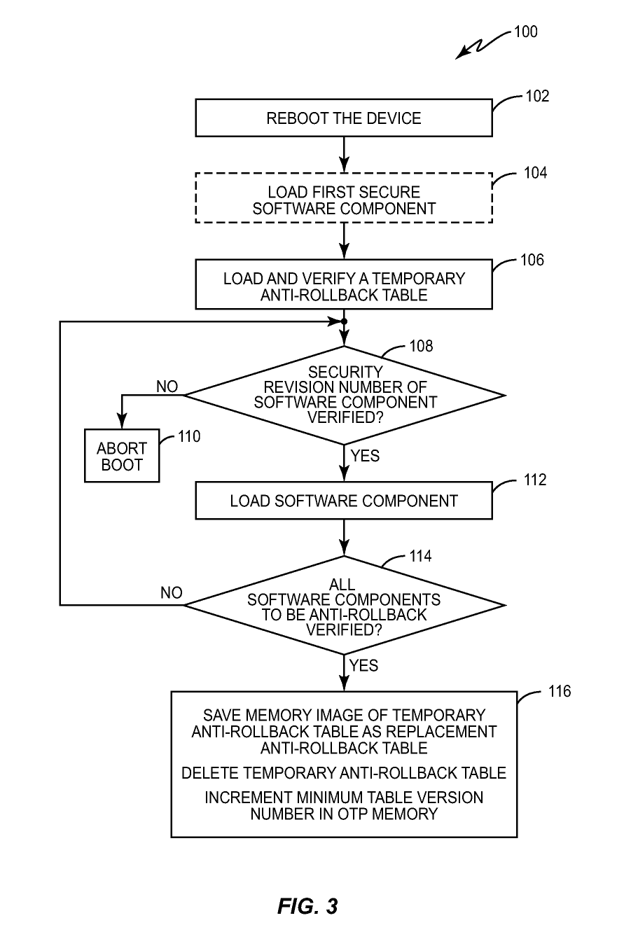

FIGS. 2 and 3 depict methods 50, 100 of creating a temporary anti-rollback table at a service center, and updating an anti-rollback table in an electronic device 10, respectively. A method 50 of creating a temporary anti-rollback table for an electronic device 10 begins by obtaining, from the electronic device, a unique device ID and a minimum required version number of an anti-rollback table (block 52). A temporary anti-rollback table, including an identification of all secure software components to be anti-rollback verified and a security revision number for each such software component, is generated (block 54). Preferably, the security revision number is the current security revision number of each corresponding software component. In one embodiment, all the security revision numbers are zero. In this embodiment, the security revision numbers in the memory image of the temporary anti-rollback table will be updated as corresponding software components are loaded, and the anti-rollback verification process discovers that their security revision numbers are greater than those in the memory image of the temporary anti-rollback table. The temporary anti-rollback table is cryptographically signed using a private key, the device ID, and the minimum required table version number (block 56). The temporary anti-rollback table is then provided to the electronic device 10 (block 58).

FIG. 3 depicts a method 100 of recovery by an electronic device 10, in which an anti-rollback table is lost or corrupted. The device 10 is re-flashed at a service center, and rebooted (block 102). The device 10 may then load a first secure software component (ISSW) (block 104), anti-rollback verifying the first secure software component against a corresponding security revision number stored in OTP memory 40. Alternatively, the boot ROM 34 code may include the required functionality. The device then loads and verifies a temporary anti-rollback table having a version number, and that has been cryptographically signed (block 106). The temporary anti-rollback table includes a minimum allowable security revision number for each of a plurality of software components. The temporary anti-rollback table may be loaded over a USB/UART interface, or from the software image flashed to non-volatile memory 18. The temporary anti-rollback table is cryptographically verified using a public key corresponding to a private key known only to the service center; the device ID with which the table was signed is verified to match the ID of the device 10; and the version number of the temporary anti-rollback table is verified to be at least as great as a minimum table version number in OTP memory 40.

For each of a plurality of software components to be loaded, the device 10 compares a security revision number of the software component to a corresponding security revision number in the memory image of the temporary anti-rollback table (block 108). If the security revision number of the software component is less than the corresponding security revision number in the memory image of the temporary anti-rollback table (block 108), the boot process is aborted (block 110). If the security revision number of the software component is equal to or greater than the corresponding security revision number in the memory image of the temporary anti-rollback table (block 108), the software component is loaded (block 112). When anti-rollback verification has been performed on all software components for which such verification is required (block 114) and memory write drivers have been loaded, the memory image of the temporary anti-rollback table is saved to non-volatile memory as a replacement anti-rollback table (block 116). The temporary anti-rollback table is deleted (block 116). To prevent re-use of the temporary anti-rollback table, the anti-rollback table minimum version number is incremented, and the corresponding version number in OTP memory 40 is updated (block 116).

Embodiments of the present invention present numerous advantages over the prior art. During recovery from a lost or damaged anti-rollback table, all protected software components are anti-rollback protected in a cost-efficient manner. The cost savings, in terms of OTP memory 40, is significant for complex, rich operating systems with numerous trusted software components. A significant advantage is provided for loader-less products such as modems in flashless bridge configuration, or products where loaders do not contain support for customization of security. In both of these configurations, almost all protected software components must be loaded to be able to successfully restore the anti-rollback table with existing solutions, yet with no way to anti-rollback protect these software components during the restore boot.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

What is claimed is:

1. A method of recovery by an electronic device having a processor and having non-volatile memory and One Time Programmable (OTP) memory, in which an anti-rollback table is lost or corrupted, comprising:
rebooting the device;
loading into memory, from a predetermined address, by boot code or a first secure software component initially loaded by boot code and executed on the processor, a temporary anti-rollback table having a version number and that has been cryptographically signed, the temporary anti-rollback table including a minimum allowable security revision number for each of a plurality of software components;
verifying the validity of the temporary anti-rollback table;
verifying, using the memory image of the temporary anti-rollback table, a security revision number of each software component subsequently loaded during the boot process; and
after an appropriate memory write driver is loaded, securely saving the memory image of the temporary anti-rollback table as a replacement anti-rollback table in non-volatile storage.

2. The method of claim 1, further comprising, prior to loading the temporary anti-rollback table into memory by the first secure software component initially loaded by boot code, verifying that a security revision number of the first secure software component is at least as great as a corresponding security revision number stored in OTP memory.

3. The method of claim 1 wherein loading the temporary anti-rollback table into memory from a predetermined address comprises reading the table over a USB or UART interface.

4. The method of claim 1 wherein loading the temporary anti-rollback table into memory from a predetermined address comprises reading the table from non-volatile memory on the device.

5. The method of claim 4 wherein reading the temporary anti-rollback table from non-volatile memory comprises:
reading the table from public non-volatile memory together with integrity information; and
verifying the integrity of the table using a unique key

6. The method of claim 4 wherein reading the temporary anti-rollback table from non-volatile memory comprises reading the table from a Replay Protected Memory Block (RPMB).

7. The method of claim 1 wherein verifying the validity of the temporary anti-rollback table comprises verifying that a device ID used in creating the cryptographic signature matches an ID of the electronic device.

8. The method of claim 1 wherein verifying the validity of the temporary anti-rollback table comprises utilizing a public key in the boot code or first software component to verify that the cryptographic signature was generated using a corresponding private key.

9. The method of claim 1 wherein verifying the validity of the temporary anti-rollback table comprises verifying that the temporary anti-rollback table version number is at least as great as a minimum required anti-rollback table version number stored in OTP memory on the electronic device.

10. The method of claim 1, further comprising, after loading the temporary anti-rollback table into memory, setting a state bit in memory to trigger a subsequent write of the memory image of the anti-rollback table as a replacement anti-rollback table, when an appropriate memory write driver has been loaded.

11. The method of claim 10 wherein securely saving the memory image of the temporary anti-rollback table as a replacement anti-rollback table comprises saving the memory image of the temporary anti-rollback table after all software components to be anti-rollback verified have been loaded, and in response to the state bit.

12. The method of claim 1, further comprising modifying the memory image of the temporary anti-rollback table in response to the security revision number update of at least one software component.

13. The method of claim 1, further comprising, upon loading a software component for which no corresponding entry exists in the memory image of the temporary anti-rollback table, updating the memory image of the temporary anti-rollback table to include the software component and an associated security revision number.

14. The method of claim 1 wherein securely saving the memory image of the temporary anti-rollback table as a replacement anti-rollback table comprises:
generating integrity data for the memory image of the temporary anti-rollback table; and
writing the memory image of the temporary anti-rollback table to non-secure, non-volatile memory as a replacement anti-rollback table, along with the integrity data.

15. The method of claim 14 wherein generating integrity data for the memory image of the temporary anti-rollback table comprises generating a Hash-based Message Authentication Code using a unique key available only in a secure operating mode.

16. The method of claim 1 wherein securely saving the memory image of the temporary anti-rollback table as a replacement anti-rollback table comprises writing the memory image of the temporary anti-rollback table to a Replay Protected Memory Block of non-volatile memory as a replacement anti-rollback table.

17. The method of claim 9 wherein securely saving the memory image of the temporary anti-rollback table as a replacement anti-rollback table comprises:
incrementing the minimum required anti-rollback table version number; and
storing the updated minimum required anti-rollback table version number in OTP memory.

18. The method of claim 1 further comprising:
loading a rich operating system (OS) and executing, by the processor, one or more applications under the rich OS; and
operating the processor in a secure mode in isolation from the rich OS and its applications.

19. The method of claim 18 wherein the processor comprises a first processing unit operative to execute the rich OS and its applications and a second processing unit isolated from the first processing unit, and wherein operating the processor in a secure mode in isolation from the rich OS and its applications comprises executing the secure mode on the second processing unit.

20. The method of claim 18 wherein the OTP memory is only accessible by the processor in secure mode.

21. A method of creating a temporary anti-rollback table for an electronic device, comprising:
obtaining from the device a unique device ID and a minimum required version number of an anti-rollback table;
generating a temporary anti-rollback table including an identification of all secure software components to be anti-rollback verified and a security revision number for each such software component;
cryptographically signing the temporary anti-rollback table using a private key, the device ID, and the minimum required table version number; and
providing the temporary anti-rollback table to the device.

22. The method of claim 21 wherein the security revision number for each software component in the temporary anti-rollback table is zero.

23. The method of claim 21 wherein the private key corresponds to a public key known to the electronic device.

24. An electronic device, comprising:
a processor;
non-volatile memory; and
One Time Programmable (OTP) memory;
wherein the processor is operative to
reboot the device;
load into memory, from a predetermined address, by boot code or a first secure software component initially loaded by boot code, a temporary anti-rollback table having a version number and that has been cryptographically signed, the temporary anti-rollback table including a minimum allowable security revision number for each of a plurality of software components;
verify the validity of the temporary anti-rollback table;
verify, using the memory image of the temporary anti-rollback table, a security revision number of each software component subsequently loaded during the boot process; and
after an appropriate memory write driver is loaded, securely save the memory image of the temporary anti-rollback table as a replacement anti-rollback table.
